(19) United States
(12) Patent Application Publication
(10) Pub. No.: US 2025/0313167 A1
(43) Pub. Date: Oct. 9, 2025

(54) MODE SETTING VALUE SET GENERATION DEVICE

(71) Applicant: TOYOTA JIDOSHA KABUSHIKI KAISHA, Toyota-shi (JP)

(72) Inventors: Takahiro ISHII, Toyota-shi (JP); Akifumi TSUKAMOTO, Toyoake-shi (JP); Ryo SUGIYAMA, Nisshin-shi (JP)

(73) Assignee: TOYOTA JIDOSHA KABUSHIKI KAISHA, Toyota-shi (JP)

(21) Appl. No.: 19/083,151

(22) Filed: Mar. 18, 2025

(30) Foreign Application Priority Data
Apr. 4, 2024 (JP) 2024-060922

(51) Int. Cl. B60R 16/037; B60H 1/00

(52) U.S. Cl. CPC B60R 16/037; B60H 1/00971

(57) ABSTRACT

An execution device acquires a plurality of pieces of setting information including information indicating a used set and change information. The execution device stores the acquired setting information in the storage device. The execution device selects the setting information satisfying the selection condition from among the plurality of setting information stored in the storage device. The execution device generates a generated set in which the setting value indicated by the change information is set as the setting value after the setting change among the setting values included in the selected setting information.

### CROSS-REFERENCE TO RELATED APPLICATION

This application claims priority to Japanese Patent Application No. 2024-060922 filed on Apr. 4, 2024, incorporated herein by reference in its entirety.

### BACKGROUND

### 1. Technical Field

The present disclosure relates to mode setting value set generation devices.

### 2. Description of Related Art

Japanese Unexamined Patent Application Publication No. 2023-93003 (JP 2023-93003 A) describes a control device for controlling a seat device that is an operation device in a relaxation mode.

### SUMMARY

In order to set the interior environment of the vehicle to an environment in a specific mode, the control device described in JP 2023-93003 A sometimes performs mode control in which the control device collectively controls a plurality of operation devices as controlled objects. When the control device performs the mode control, the control device needs a mode setting value set including setting values for each of the operation devices. However, setting the setting values for each of the operation devices for each mode may excessively increase a burden on the developer.

The present disclosure is a mode setting value set generation device configured to generate a mode setting value set that is used to perform mode control. The mode control is control for collectively controlling a plurality of operation devices mounted on a vehicle in order to set an interior environment of the vehicle to an environment for a specific mode. The mode setting value set is a setting value set in which a setting value for each of the operation devices is determined.

The mode setting value set generation device includes
a storage unit, and an execution unit.
   The execution unit is configured to
acquire a plurality of pieces of setting information from the vehicle, the setting information including information indicating a used set and change information, the used set being the mode setting value set used in the mode control, and the change information indicating a content of change in the setting value subjected to a setting change out of the used set when the mode control is performed,
store the acquired pieces of setting information in the storage unit,
select the setting information that satisfies a predetermined selection condition from the pieces of setting information stored in the storage unit, and
generate the mode setting value set that includes, as the setting value after the setting change, the setting value subjected to the setting change out of the setting values included in the used set in the selected setting information.

The mode setting value set generation device can generate, from the used set subjected to the setting change and acquired from the vehicle, the mode setting value set including the setting value after the setting change. Therefore, the mode setting value set generation device can reduce an excessive increase in burden on the developer due to setting the setting values for each of the operation devices for each mode.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram showing a vehicle;

FIG. 2 is a schematic diagram illustrating a generation system for generating a mode setting value set;

FIG. 3 is a schematic diagram showing a plurality of combination data; and

FIG. 4 is a flowchart illustrating a series of processes including a process of generating a generated set.

### DETAILED DESCRIPTION OF EMBODIMENTS

### Embodiment

Hereinafter, an embodiment of a mode setting value set generation device will be described with reference to the drawings. First, a vehicle that performs mode control will be described.

### Outline of Vehicle

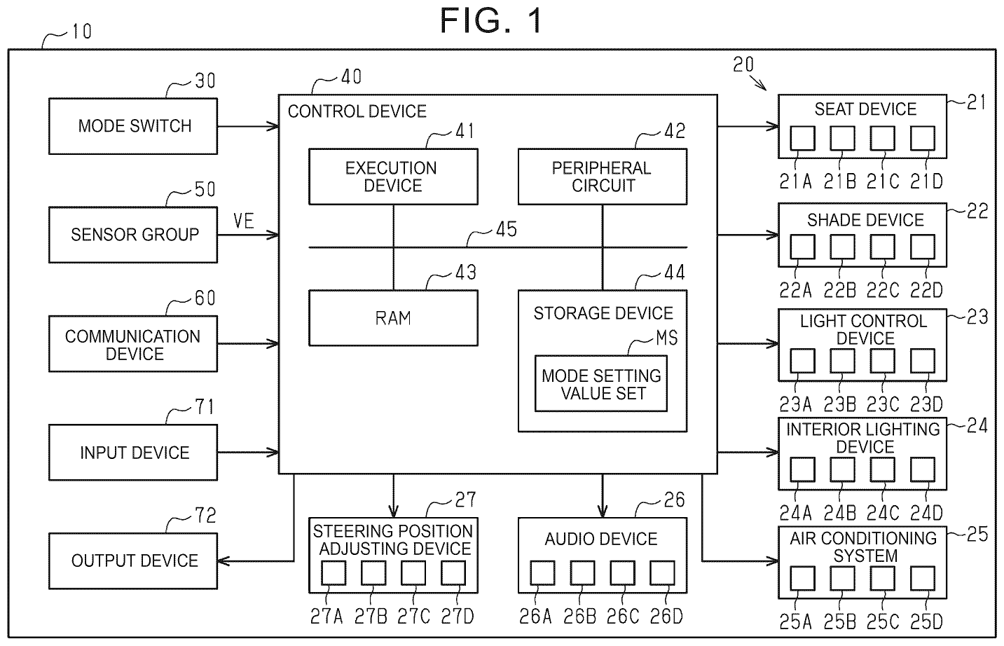

As illustrated in FIG. 1, the vehicle 10 includes a plurality of operation devices 20. That is, the plurality of operation devices 20 are mounted on the vehicle 10. The operation device 20 is a device that affects the interior environment of the vehicle 10 by operating.

The plurality of operation devices 20 includes a seat device 21, a shade device 22, a light control device 23, an interior lighting device 24, an air conditioner 25, an audio device 26, and a steering position adjustment device 27.

The seat device 21 affects the attitude of the occupant in the vehicle 10 while the occupant is in the vehicle. The seat device 21 includes a seat body 21A and a seat operation mechanism 21B that operates the seat body 21A. Further, the seat device 21 includes a seat actuator 21C that operates the seat operation mechanism 21B, and a control unit 21D that controls the seat actuator 21C.

The seat body 21A includes a seat cushion and a seat back. The seat cushion is slidably connected to the vehicle 10 through a slide mechanism such as a seat operation mechanism 21B provided on the floor of the vehicle 10. The slide mechanism includes a lower rail fixed to the floor of the vehicle 10 and an upper rail attached to the lower rail so as to be slidable in the front-rear direction. Driving the sliding motor of the seat actuator 21C causes the upper rail to slide relative to the lower rail. In this way, the seat device 21 has a sliding function of the seat body 21A.

The seat back is connected to a rear end portion of the seat cushion of the seat body 21A so as to be rotatable with respect to the seat cushion through a reclining mechanism of the seat operation mechanism 21B. By driving the reclining motor of the seat actuator 21C, the seat back rotates with respect to the seat cushion with an axis extending in the widthwise direction of the vehicle 10 as a rotation axis. In this way, the seat device 21 has a reclining function of the seat body 21A.

When a seat operating switch (not shown) is operated, the control unit 21D drives the reclining motor of the seat actuator 21C. Thus, the control unit 21D controls the slide position, which is the vehicle front-rear position of the seat body 21A. Further, the control unit 21D drives the reclining motor of the seat actuator 21C by operating a seat operating switch (not shown). Thus, the control unit 21D controls the reclining position, which is the angle of the seat back with respect to the seat cushion.

The shade device 22 affects the brightness of the interior environment of the vehicle 10, the opening feeling of the occupant in the vehicle 10, and the like by changing the range covering the window glass in the vehicle 10. One shade device 22 is provided for each window glass. In the present embodiment, the shade device 22 is provided in each of the roof glass provided on the roof of the vehicle 10 and the rear glass provided on the rear of the vehicle 10. In FIG. 1, only one shade device 22 is illustrated.

The shade device 22 includes a shade body 22A and a shade operation mechanism 22B that operates the shade body 22A. Further, the shade device 22 includes a shade actuator 22C that operates the shade operation mechanism 22B, and a control unit 22D that controls the shade actuator 22C.

The shade body 22A is a curtain body that covers the glass of the vehicle 10 from inside the cabin of the vehicle 10. The shade body 22A is operatively connected via a shade operation mechanism 22B so as to be in a closed state covering the glass and an open state not covering the glass. When the shade body 22A is wound up by the driving of the motor that is the shade actuator 22C, the shade body 22A is opened. Further, the shade body 22A is rewound by the driving of the shade actuator 22C, so that the shade body 22A is closed. In this way, the shade device 22 has the shade function of the shade body 22A.

When a roof shade operating switch (not shown) is operated, the control unit 22D drives the shade actuator 22C of the shade device 22 provided in the roof glass. Thus, the control unit 22D controls the opening and closing of the shade device 22 provided in the roof glass. Further, the control unit 22D drives the shade actuator 22C of the shade device 22 provided in the rear glass by operating a rear shade operating switch (not shown). Thus, the control unit 22D controls the opening and closing of the shade device 22 provided in the rear glass.

The light control device 23 changes the light transmittance of the window glass in the vehicle 10, thereby affecting the amount of light inserted into the interior of the vehicle 10 from the outside. The light control device 23 includes a light control glass 23A, a light control mechanism 23B that changes the light transmittance of the light control glass 23A, a light control actuator 23C that operates the light control mechanism 23B, and a control unit 23D that controls the light control actuator 23C.

The light control device 23 is provided on a roof glass of the vehicle 10. The light control glass 23A is a roof glass of the vehicle 10. The light control glass 23A includes two glass layers and a light control film layer sandwiched between the two glass layers. The light control film layer changes the dispersal and orientation of the micro-materials contained in the light control film layer according to the applied voltage by the light control mechanism 23B. The light control actuator 23C is driven to drive the light control film. As a result, the operation of the dispersion and the orientation of the minute material contained in the light control film layer is changed. As a consequence, the light control glass 23A becomes a light control mode in which the light transmittance from the outside of the vehicle 10 is low due to the applied voltage, or a transmission mode in which the light transmittance from the outside of the vehicle 10 is high due to the transparency. In this way, the light control device 23 has a light control function of the light control glass 23A.

The control unit 23D drives the light control actuator 23C by operating a light control operation switch, not shown. Thus, the control unit 23D controls the condition of the light control glass 23A.

The interior lighting device 24 changes the mode of lighting for illuminating the interior of the vehicle 10, thereby affecting the brightness and the like of the interior of the vehicle 10. The interior lighting device 24 includes a lamp 24A including a light-emitting mechanism 24B, a lighting actuator 24C for operating the light-emitting mechanism 24B, and a control unit 24D for controlling the lighting actuator 24C.

The interior lighting device 24 is provided in the cabin of the vehicle 10. The lamp 24A is, for example, a LED. When the light-emitting mechanism 24B is operated by driving a switch that is a lighting actuator 24C, the lamp 24A is in a lighting state or a non-lighting state. In addition, the lamp 24A can realize fade-in lighting and fade-out lighting by driving the lighting actuator 24C. In this way, the interior lighting device 24 has a lighting function.

The control unit 24D controls the driving of the lighting actuator 24C by operating an illumination switch (not shown). Thus, the control unit 24D controls the status of the lamp 24A. In the present embodiment, the vehicle 10 includes a plurality of interior lighting devices 24.

The air conditioner 25 adjusts the temperature in the vehicle 10, thereby affecting the temperature environment such as the temperature in the cabin of the vehicle 10. The air conditioner 25 includes an air conditioner body 25A including an air conditioning mechanism 25B, an air conditioning actuator 25C for operating the air conditioning mechanism 25B, and a control unit 25D for controlling the air conditioning actuator 25C.

The air outlet of the air conditioner body 25A is provided so as to blow air toward the space in the cabin of the vehicle 10. By operating the air conditioning mechanism 25B by driving the air compressor and the heat exchanger, which are air conditioning actuator 25C, the air conditioner body 25A sends the temperature-adjusted air from the air outlet. In this way, the air conditioner 25 has an air-conditioning function.

The control unit 25D controls driving of the air-conditioning actuator 25C by operating an air-conditioning switch (not shown). Thus, the control unit 25D controls the air blowing condition from the air blowing port of the air conditioner body 25A.

The audio device 26 affects the sound environment in the cabin of the vehicle 10 by changing the audio output in the vehicle 10. The audio device 26 includes a speaker 26A including an audio mechanism 26B, an audio actuator 26C that operates the audio mechanism 26B, and a control unit 26D for controlling the audio actuator 26C.

The speaker 26A outputs audio by operating the audio mechanisms 26B inside the vehicle 10. When the audio actuator 26C is vibrated, the speaker 26A outputs audio due to the vibration. In this way, the audio device 26 has an audio function.

When an audio switch (not shown) is operated, the control unit 26D drives the audio actuator 26C. Thus, the control unit 26D controls the audio output from the speaker 26A.

The steering position adjusting device 27 adjusts the position of the steering wheel 27A in the vehicle 10, thereby affecting the space of the driver's seat in the vehicle 10. The steering position adjusting device 27 includes a steering wheel 27A and a position adjustment mechanism 27B capable of adjusting the position of the steering wheel 27A. The steering position adjusting device 27 includes a position adjustment actuator 27C that operates the position adjustment mechanism 27B and a control unit 27D that controls the position adjustment actuator 27C.

The steering wheel 27A is provided in the driver's seat of the vehicle 10. The position of the steering wheel 27A can be adjusted in the front-rear direction and the up-down direction of the vehicle 10 by the position adjustment mechanism 27B. The position adjustment mechanism 27B realizes a so-called tilt and telescopic function. The position of the steering wheel 27A in the vehicle 10 is changed by the driving of the motor which is the position adjustment actuator 27C. In this way, the steering position adjustment device 27 has a position adjustment function.

When a steering position adjustment switch (not shown) is operated, the control unit 27D drives the position adjustment actuator 27C. Thus, the control unit 27D controls the position of the steering wheel 27A.

As described above, the plurality of operation devices 20 can be individually operated by operating switches provided for each operation device 20. The vehicle 10 includes a mode switch 30 and a control device 40. The mode switch 30 is operated by a user to output a signal indicating that mode control is performed in a mode for collectively controlling the plurality of operation devices 20 to the control device 40. In addition, the mode switch 30 outputs a signal indicating a mode in which mode control is performed to the control device 40 in response to an operation by the user.

The control device 40 collectively controls the plurality of operation devices 20 by mode control. The control device 40 acquires a signal indicating that mode control is performed from the mode switch 30. Further, the control device 40 acquires a signal indicating a mode in which mode control is performed from the mode switch 30. Each mode is a mode for realizing the interior environment of the vehicle 10.

The control device 40 includes a CPU that is the execution device 41, a peripheral circuit 42, a RAM 43, a storage device 44, and a bus 45. The bus 45 connects the execution device 41, the peripheral circuit 42, RAM 43, and the storage device 44 so as to be able to communicate with each other. The execution device 41 performs information processing by executing various programs stored in the storage device 44. The peripheral circuit 42 includes a circuit that generates a clock signal that defines an internal operation, a power supply circuit, a reset circuit, and the like. RAM 43 stores information generated by the execution device 41. The storage device 44 stores a mode setting value set MS to be used in accordance with the mode control.

The mode setting value set MS is a data set that defines the setting value SV of the operation device 20 corresponding to the mode for realizing the interior environment of the vehicle 10. Therefore, the mode setting value set MS is set for each mode. The mode setting value set MS includes information indicating a mode, information indicating an operation device 20 to be operated, and setting value SV indicating an operation content of the operation device 20 to be operated.

Upon acquiring a signal indicating that the mode control is performed from the mode switch 30, the execution device 41 starts executing the mode control. When the execution of the mode control is started, the execution device 41 determines the mode based on the mode acquired from the mode switch 30 and the mode setting value set MS. Next, the execution device 41 refers to the mode setting value set MS to determine the operation device 20 to be operated in the determined mode. Next, the execution device 41 refers to the setting value SV of the mode setting value set MS to determine the operation content of the operation device 20 to be operated as determined. Then, the execution device 41 causes the determined operation device 20 that is to be operated to operate with the determined operation content. After the operation of the operation content is performed, the execution device 41 ends the series of processes.

The vehicle 10 includes a sensor group 50 including a plurality of sensors and a communication device 60. The sensor group 50 includes a plurality of sensors for acquiring vehicle environment information VE indicating the vehicle environment of the vehicle 10. The sensor group 50 detects, for example, the outside air temperature range TO of the vehicle 10, the weather W of the area where the vehicle 10 is located, and the time of day TM including the time in the area where the vehicle 10 is located. Further, the sensor group 50 detects the type of the road on which the vehicle 10 is traveling, the brightness around the position where the vehicle 10 is located, and the number of passengers of the vehicle 10. The sensor group 50 outputs the detected vehicle environment information VE to the control device 40. The communication device 60 is capable of performing wireless communication with the outside of the vehicle 10 via a wireless communication network.

The vehicle 10 includes an input device 71 and an output device 72. The input device 71 is operated to input information to the control device 40. The output device 72 outputs information from the control device 40. Specifically, the input device 71 and the output device 72 are implemented as a touch display. In the present embodiment, the output device 72 outputs an image indicating information.

### Generation System

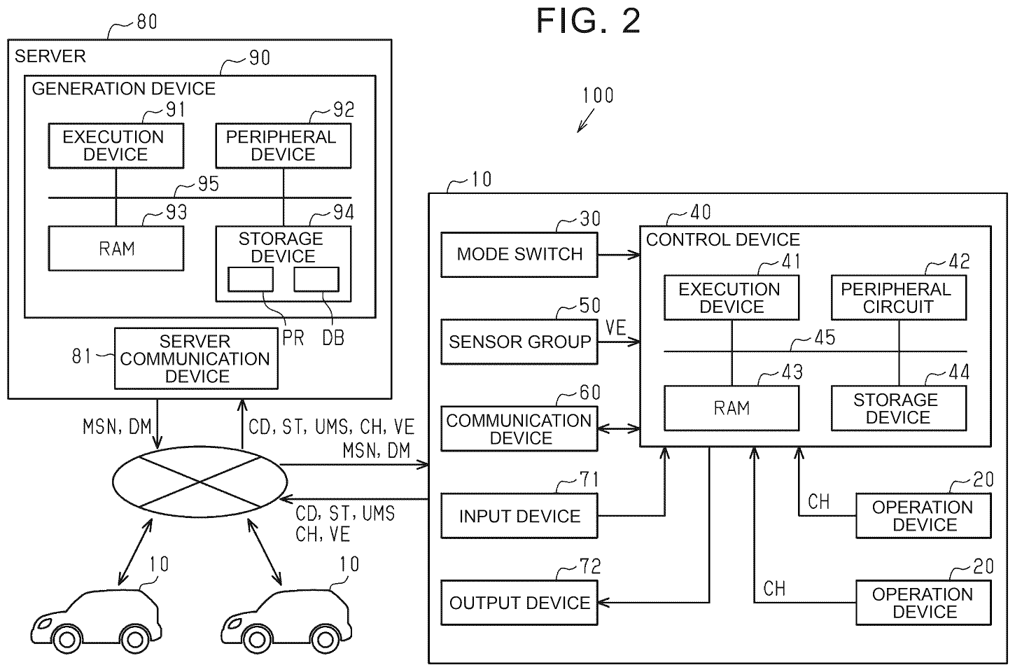

As illustrated in FIG. 2, the generation system 100 includes a plurality of vehicles 10 and a server 80. Note that one vehicle 10 out of the plurality of vehicles 10 is shown in detail, and the other vehicles 10 are not shown in detail. Further, a plurality of operation devices 20 of the vehicle 10 are partially omitted.

When the mode is controlled by operating the mode switch 30, the control device 40 acquires information indicating the used set UMS which is the mode setting value set MS used in the mode control. In addition, the control device 40 acquires the change information CH subjected to the setting change when the setting value SV is individually changed by operating a switch provided in the operation device 20 while the mode control is being performed using the used set UMS. The change information CH is, for example, information indicating the reclining position after the change in the seat device 21. The change information CH is, for example, information indicating that the shade device 22 has been changed from the open state to the closed state. The change information CH is, for example, information indicating that the light control device 23 has changed from the light control mode to the transmission mode. In addition, the control device 40 acquires, from the sensor group 50, the vehicle environment information VE when the mode control is performed using the used set UMS.

The communication device 60 of the vehicle 10 can wirelessly communicate with the server 80 via a wireless communication network. The control device 40 of the vehicle 10 generates the combination data CD indicating the combination of: the setting information ST including the information indicating the used set UMS and the change information CH; and the vehicle environment information VE when the mode control is performed using the used set UMS. When the change information CH is acquired, the control device 40 sends the generated combination data CD from the communication device 60 to the server 80.

The server 80 includes a server communication device 81 and a generation device 90. The server communication device 81 is capable of wirelessly communicating with the vehicle 10 via a wireless communication network. The generation device 90 is a device that generates the mode setting value set MS based on the information received by the server communication device 81.

The generation device 90 includes an execution device 91 that is a CPU, a peripheral circuit 92, a RAM 93, a storage device 94, and a bus 95. In the present embodiment, the execution unit is the execution device 91, and the storage unit is the storage device 94. The bus 95 communicatively connects the execution device 91, the peripheral circuit 92, RAM 93, and the storage device 94 to each other. The execution device 91 performs information processing by executing various programs stored in the storage device 94. The peripheral circuit 92 includes a circuit that generates a clock signal that defines an internal operation, a power supply circuit, a reset circuit, and the like. RAM 93 stores data generated in association with execution by the execution device 91. The storage device 94 stores a generation program PR for generating the mode setting value set MS and a database DB used in executing the generation program PR.

Each time the combination data CD is acquired from the vehicle 10, the execution device 91 stores the acquired combination data CD in the database DB. As a result, the generation device 90 acquires a plurality of combination data CD, so that the database DB includes a plurality of combination data CD.

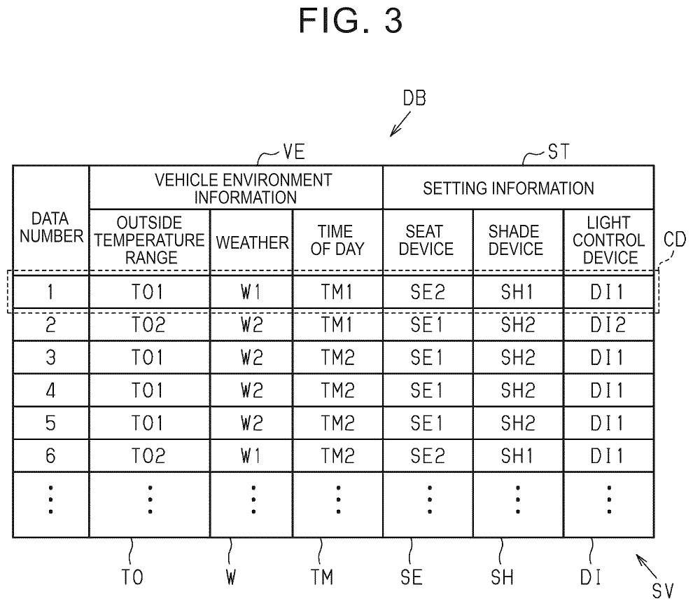

As shown in FIG. 3, the database DB includes a plurality of combination data CD. The combination data CD are assigned data numbers in the order in which they are stored.

The vehicle environment information VE includes, for example, an outside air temperature range TO, a weather W, and time of day TM. The outside air temperature range TO is a temperature range including the outside air temperature among a plurality of predetermined temperature ranges. For example, the plurality of temperature ranges indicates whether or not the temperature range exceeds 30 degrees Celsius. In the present embodiment, the first outside air temperature range TO1 is a temperature range exceeding 30 degrees Celsius. The second outside air temperature range TO2 is a temperature range of 30 degrees Celsius or less.

The weather W indicates whether there is rainfall. In the present embodiment, the first weather W1 is rainy. The second weather W2 is free of rainfall. The time of day TM is a range including a time at which another vehicle environment information VE is acquired among a plurality of predetermined time ranges. In the present embodiment, the first time of day TM1 is a period from sunrise to sunset in one day. The second time of day TM2 is from sunset to sunrise in one day.

The setting information ST includes information indicating an operation device to be operated and a setting value SV indicating an operation content as information indicating the used set UMS. In the present embodiment, the operation device 20 to be operated is the seat device 21, the shade device 22, and the light control device 23.

The plurality of setting values SV include, for example, seat information SE of the seat device 21, a shade information SH of the shade device 22, and a light control information DI of the light control device 23. The seat information SE indicates whether or not the reclining position is a specified position. In the present embodiment, the first seat information SE1 indicates a first specified position. The second seat information SE2 indicates change from the first specified position to the second specified position different from the first specified position. That is, the second seat information SE2 is the change information CH.

The shade information SH indicates whether the shade device 22 is in an open state or a closed state. In the present embodiment, the first shade information SH1 indicates that the shade device 22 is open. The second shade information SH2 indicates that the shade device 22 has been changed from the open state to the closed state. That is, the second shade information SH2 is the change information CH.

The light control information DI indicates whether the light control device 23 is in the light control mode or the transmission mode. In the present embodiment, the first light control information DI1 indicates that the light control device 23 is in the light control mode. The second light control information DI2 indicates that the light control device 23 has been changed from the light control mode to the transmission mode. That is, the second light control information DI2 is the change information CH.

### Generation of Mode Setting Value Set

The execution device 91 starts execution of the generation program PR at predetermined specified periods. The specified period is, for example, 24 hours.

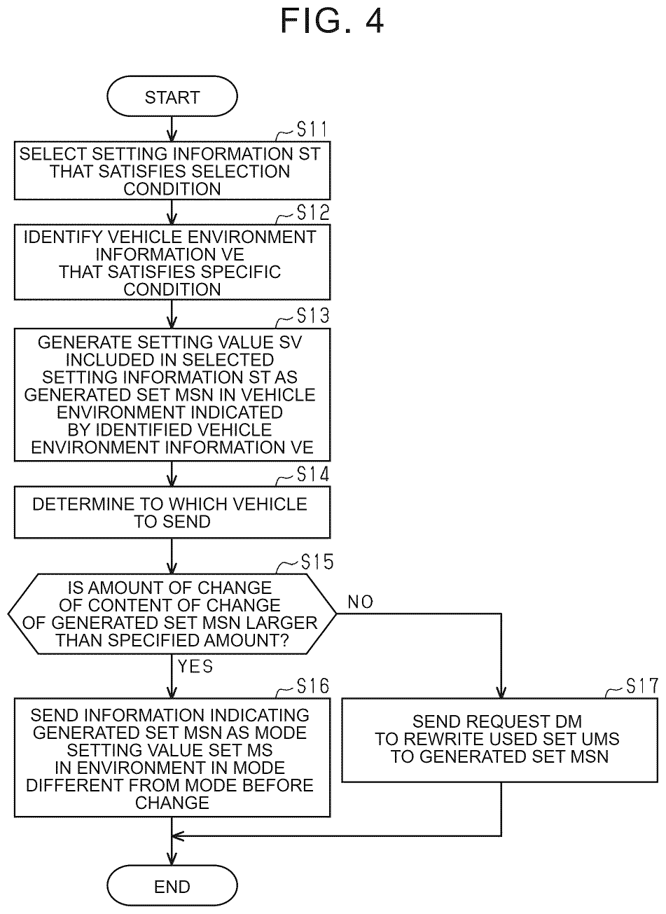

As illustrated in FIG. 4, when the execution device 91 starts execution of the generation program PR, S11 process is started first. In S11, the execution device 91 refers to the database DB stored in the storage device 94 and selects the setting information ST satisfying the predetermined selection condition in the combination indicated by the plurality of combination data CD. The selection criterion is that the number of combinations of the same setting value SV is equal to or greater than a predetermined specified number with the setting change indicated by the change information CH being made. The combination of the same setting value SV is a combination in which a plurality of setting values SV included in the setting information ST all coincide with each other. In the present embodiment, the two pieces of setting information ST have the same setting value SV when the seat information SE, the shade information SH, and the light control information DI included in the two pieces of setting information ST to be compared all match. The specified number is set to, for example, 100. In the present embodiment, the execution device 91 selects the setting information ST including the first seat information SE1, the second shade information SH2, and the first light control information DI1. Thereafter, the execution device 91 advances the process to S12.

In S12, the execution device 91 specifies the vehicle environment information VE satisfying the predetermined specification condition among the vehicle environment information VE of the combination including the selected setting information ST. The specifying condition is that a ratio of the number of combinations that are the same vehicle environment information VE to the number of combinations including the selected setting information ST is equal to or greater than a predetermined specified ratio. The specified ratio is set at 80%, for example. In the present embodiment, the execution device 91 specifies the vehicle environment information VE including the first outside air temperature range TO1, the second weather W2, and the second time of day TM2. Thereafter, the execution device 91 advances the process to S13.

In S13, the execution device 91 generates the setting value SV subjected to the setting change and included in the selected setting information ST as the generated set MSN that is the mode setting value set MS in the vehicle environment indicated by the specified vehicle environment information VE. In other words, the execution device 91 sets the combination of the setting value SV reflecting the setting change indicated by the change information CH included in the selected setting information ST as the combination of the setting value SV of the generated set MSN. Thereafter, the execution device 91 advances the process to S14.

In S14, the execution device 91 determines the vehicle 10 to which the generated set MSN is to be sent. The execution device 91 determines the vehicle 10 that has sent the combination data CD including the selected setting information ST as the destination vehicle 10. On the other hand, the execution device 91 does not designate the vehicle 10 that has not sent the combination data CD including the selected setting information ST as the destination vehicle 10. Thereafter, the execution device 91 advances the process to S15.

In S15, the execution device 91 determines whether the amount of change of the content of change in the generated set MSN is larger than a predetermined specified amount. Specifically, the amount of change is the number of setting value SV having the change information CH among the plurality of setting value SV. The specified amount is, for example, two. When the amount of change of the content of change in the generated set MSN is larger than the specified amount (S15: YES), the execution device 91 advances the process to S16.

In S16, the execution device 91 sends information indicating the generated set MSN to the destination vehicle 10 determined by S14 as the mode setting value set MS when performing the mode setting control for setting the mode in the mode differing from the mode setting value set MS prior to the change. That is, the generation device 90 adds one mode setting value set MS. Thereafter, the execution device 91 ends the series of processes.

On the other hand, when the amount of change of the content of change in the generated set MSN is equal to or less than the specified amount (S15: NO), the execution device 91 advances the process to S17.

In S17, the execution device 91 sends the requested DM for rewriting the used set UMS to the generated set MSN to the destination vehicle 10 determined by S14. Thereafter, the execution device 91 ends the series of processes.

### Effects of Embodiment

(1) According to the above embodiment, the generation device 90 selects the setting information ST satisfying the selection condition, and thereby generates the generated set MSN reflecting the setting change indicated by the selected setting information ST. Therefore, the generation device 90 can generate the generated set MSN without the developer designing all the setting value SV of each of the operation devices 20 for each mode. Therefore, the generation device 90 can suppress an excessively large burden on the developer by setting the setting value SV of each of the operation devices 20 for each mode.

(2) According to the above embodiment, the combination data CD includes vehicle environment information VE. Therefore, the generation device 90 acquires the vehicle environment information VE together with the setting information ST. Then, the generation device 90 generates the generated set MSN as the mode setting value set MS in the vehicle environment indicated by the vehicle environment information VE. Therefore, the generation device 90 can generate the generated set MSN without the developer designing all the mode setting value set MS for each vehicle environment. Therefore, the generation device 90 can suppress an excessively large burden on the developer by generating the mode setting value set MS for each vehicle environment.

(3) According to the above embodiment, the generation device 90 sends the information indicating the generated set MSN from the server communication device 81 only to the vehicle 10 that has sent the combination data CD including the selected setting information ST. Therefore, the server 80 can provide the mode setting value set MS suitable for each of the vehicles 10.

(4) According to the above embodiment, the generation device 90 changes the way in which the information indicating the generated set MSN is reflected on the vehicle 10 in accordance with the amount of change subjected to the setting change indicated by the change information CH. Specifically, when the amount of change subjected to the setting change is larger than the specified amount, the generation device 90 sends, from the server communication device 81 to the vehicle 10, the information indicating the generated set MSN as the mode setting value set MS of the mode different from the mode of the used set UMS. On the other hand, when the amount of change subjected to the setting change is equal to or less than the specified amount, the generation device 90 sends the requested DM to rewrite the used set UMS to the generated set MSN from the server communication device 81 to the vehicle 10. Thus, in the vehicle 10, the control device 40 can use the generated set MSN as the control in another mode if the setting is large and can use the generated set MSN as the used set UMS if the setting is small.

### Other Embodiments

The present embodiment can be realized with the following modifications. The present embodiment and the following modifications can be combined with each other within a technically consistent range to be realized.

The plurality of operation devices 20 preferably include at least two of the following devices: the seat device 21, the shade device 22, the light control device 23, the interior lighting device 24, the air conditioner 25, and the audio device 26. In this case, by giving various sensations to the user of the vehicle 10, it is easy to realize the interior environment of the vehicle 10 differently. The plurality of operation devices 20 may include a steering position adjustment device 27.

The selection condition and the specific condition are not limited to the example of the above embodiment. For example, the selection condition may be a condition for selecting a vehicle environment information VE in which part of the parameters matches among the parameters included in the vehicle environment information VE.

The generation device 90 may not acquire the vehicle environment information VE together with the setting information ST. In this case, the generation device 90 may generate the generated set MSN as the mode setting value set MS that is not associated with the vehicle environment.

The generation device 90 may send the information indicating the generated set MSN to the vehicle 10 that has not sent the selected setting information ST.
The generation device 90 may not change the way in which the information indicating the generated set MSN is reflected on the vehicle 10 according to the amount of change in the setting change indicated by the change information CH. For example, when the amount of change in the setting change indicated by the change information CH is larger than the specified amount, the generation device 90 may send the requested DM to overwrite the generated set MSN instead of the used set UMS to the vehicle 10.

What is claimed is:

1. A mode setting value set generation device configured to generate a mode setting value set that is used to perform mode control, the mode control being control for collectively controlling a plurality of operation devices mounted on a vehicle in order to set an interior environment of the vehicle to an environment for a specific mode, and the mode setting value set being a setting value set in which a setting value for each of the operation devices is determined, the mode setting value set generation device comprising:
a storage unit; and
an execution unit,
wherein the execution unit is configured to
acquire a plurality of pieces of setting information from the vehicle, the setting information including information indicating a used set and change information, the used set being the mode setting value set used in the mode control, and the change information indicating a content of change in the setting value subjected to a setting change out of the used set when the mode control is performed,
store the acquired pieces of setting information in the storage unit,
select the setting information that satisfies a predetermined selection condition from the pieces of setting information stored in the storage unit, and
generate the mode setting value set that includes, as the setting value after the setting change, the setting value subjected to the setting change out of the setting values included in the used set in the selected setting information.

2. The mode setting value set generation device according to claim 1, wherein the execution unit is configured to
when acquiring the setting information, acquire vehicle environment information together with the setting information, the vehicle environment information indicating a vehicle environment of the vehicle when the mode control is performed, and
when generating the mode setting value set, generate, as the mode setting value set for the vehicle environment, the mode setting value set including the setting value after the setting change.

3. The mode setting value set generation device according to claim 1, wherein the execution unit is further configured to send information indicating the generated mode setting value set to the vehicle that has sent the selected setting information, and not send the information indicating the generated mode setting value set to the vehicle that has not sent the selected setting information.

4. The mode setting value set generation device according to claim 1, wherein the execution unit is further configured to
determine whether an amount of change of the content of change indicated by the change information is larger than a predetermined specified amount,
when the amount of change is larger than the specified amount, send, as the mode setting value set for providing the environment for the mode different from the mode of the used set, information indicating the generated mode setting value set to the vehicle, and
when the amount of change is equal to or less than the specified amount, send to the vehicle a request to rewrite the used set with the generated mode setting value set.

5. The mode setting value set generation device according to claim 1, wherein the operation devices include at least two of the following devices: a seat device, a shade device, a light control device, an interior lighting device, an air conditioner, and an audio device.
